(19) United States
(12) Patent Application Publication
(10) Pub. No.: US 2025/0148194 A1
(43) Pub. Date: May 8, 2025

(54) SYSTEMS AND METHODS FOR DETERMINING POTENTIAL SUBJECT MATTER CONFLICTS AMONG PATENT MATTERS

(71) Applicant: Paximal, Inc., Los Angeles, CA (US)

(72) Inventors: Ian C. Schick, Ojai, CA (US); Kevin Knight, Marina del Rey, CA (US)

(21) Appl. No.: 19/015,199

(22) Filed: Jan. 9, 2025

Related U.S. Application Data
(63) Continuation of application No. 17/230,548, filed on Apr. 14, 2021, now abandoned.
Application No. 17/230,548 is a continuation-in-part of application No. 16/840,236, filed on Apr. 3, 2020, now Pat. No. 11,023,662.
Application No. 16/840,236 is a continuation of application No. 16/221,070, filed on Dec. 14, 2018, now abandoned.
Application No. 16/221,070 is a continuation-in-part of application No. 15/892,679, filed on Feb. 9, 2018, now Pat. No. 10,417,341.
(60) Provisional application No. 62/599,588, filed on Dec. 15, 2017.
(60) Provisional application No. 62/626,222, filed on Feb. 5, 2018.
(60) Provisional application No. 62/459,357, filed on Feb. 15, 2017.
(60) Provisional application No. 62/459,199, filed on Feb. 15, 2017.
(60) Provisional application No. 62/459,208, filed on Feb. 15, 2017.
(60) Provisional application No. 62/459,246, filed on Feb. 15, 2017.
(60) Provisional application No. 62/459,235, filed on Feb. 15, 2017.
(60) Provisional application No. 62/705,315, filed on Jun. 22, 2020.
(60) Provisional application No. 62/705,316, filed on Jun. 22, 2020.
(60) Provisional application No. 62/705,317, filed on Jun. 22, 2020.

(51) Int. Cl. G06F 40/166; G06F 16/35; G06F 16/38; G06F 40/289

(52) U.S. Cl. CPC G06F 40/166; G06F 16/35; G06F 16/38; G06F 40/289

(57) ABSTRACT

Methods, systems, and storage media for determining potential subject matter conflicts among patent matters are disclosed. Exemplary implementations may: obtain two or more documents associated with patent documents; determine a topical distance between the two or more documents, a first topical distance being the topical distance between the first document and the second document; determine whether the topical distance between the two or more document breaches a threshold, a first threshold being associated with the first topical distance between the first document and the second document; and responsive to a determination that the topical distance breaches the threshold, provide an indication that the threshold was breached.

### CROSS-REFERENCE TO RELATED APPLICATIONS

This application is related to U.S. Nonprovisional application Ser. No. 15/892,679, filed Feb. 9, 2018 and entitled “SYSTEMS AND METHODS FOR USING MACHINE LEARNING AND RULES-BASED ALGORITHMS TO CREATE A PATENT SPECIFICATION BASED ON HUMAN-PROVIDED PATENT CLAIMS SUCH THAT THE PATENT SPECIFICATION IS CREATED WITHOUT HUMAN INTERVENTION”; U.S. Nonprovisional application Ser. No. 15/936,239, filed Mar. 26, 2018 and entitled “SYSTEMS AND METHODS FOR FACILITATING EDITING OF A CONFIDENTIAL DOCUMENT BY A NON-PRIVILEGED PERSON BY STRIPPING AWAY CONTENT AND MEANING FROM THE DOCUMENT WITHOUT HUMAN INTERVENTION SUCH THAT ONLY STRUCTURAL AND/OR GRAMMATICAL INFORMATION OF THE DOCUMENT ARE CONVEY”; U.S. Nonprovisional application Ser. No. 15/994,756, filed May 31, 2018 and entitled “MACHINE LEARNING MODEL FOR COMPUTER-GENERATED PATENT APPLICATIONS TO PROVIDE SUPPORT FOR INDIVIDUAL CLAIM FEATURES IN A SPECIFICATION”; U.S. Nonprovisional application Ser. No. 16/025,687, filed Jul. 2, 2018 and entitled “SYSTEMS AND METHODS FOR AUTOMATICALLY CREATING A PATENT APPLICATION BASED ON A CLAIM SET SUCH THAT THE PATENT APPLICATION FOLLOWS A DOCUMENT PLAN INFERRED FROM AN EXAMPLE DOCUMENT”; and U.S. Nonprovisional application Ser. No. 16/025,720, filed Jul. 2, 2018 and entitled “SYSTEMS AND METHODS FOR IDENTIFYING FEATURES IN PATENT CLAIMS THAT EXIST IN THE PRIOR ART”, all of which are hereby incorporated by reference in their entireties.

### FIELD OF THE DISCLOSURE

The present disclosure relates to methods, systems, and storage media for determining potential subject matter conflicts among patent matters.

### BACKGROUND

In many jurisdictions, including in the United States, subject matter conflicts may exist where there is simultaneous representation of clients competing for patents in the same technology area. In either client's view, this “conflict” may support claims for breach of fiduciary duty, legal malpractice, unfair or deceptive business practices, and inequitable conduct before the United States Patent & Trademark Office. As a result of a subject matter conflict, a client may allege that the law firm had given preferential treatment to the competitor client and was enriched to the client's detriment as a consequence. Often, in a law firm setting, when a new patent matter is opened, the title (or other summarized information) of the underlying invention is communicated to each practitioner in the patent practice with the question: Does this new patent matter present a potential subject matter conflict with any existing patent matter? Generally, this communication is an email and, as such, requires practitioner time to check and evaluate. Hundreds of new patent matters times, for large practices, over one hundred practitioners means that potentially tens of thousands of subject matter conflicts check emails are sent each year.

### SUMMARY

Exemplary implementations augment patent practice with machine learning and natural language processing and generation technologies. Conventional subject matter conflicts checks create undue labor when the potential conflict being checked is only relevant to a subset of a patent practice. While it is important to be thorough, there may be diminishing returns for assessing subject matter conflicts for situations where a lack of potential conflict is obvious on its face.

Implementations described herein address these and other problems by determining potential subject matter conflicts among patent matters by determining a topical distance between patent documents. As such, a law firm can reduce the total subject matter conflict check communications by only sending such communications to practitioners who have worked on patent matters with a topical distance to a new patent matter that breaches a threshold.

One aspect of the present disclosure relates to a method for determining potential subject matter conflicts among patent matters. The method may include obtaining two or more documents associated with patent documents. The two or more documents may include a first document and a second document. The method may include determining a topical distance between the two or more documents, a first topical distance being the topical distance between the first document and the second document. The method may include determining whether the topical distance between the two or more document breaches a threshold, a first threshold being associated with the first topical distance between the first document and the second document. The method may include, responsive to a determination that the topical distance breaches the threshold, providing an indication that the threshold was breached.

In some implementations of the method, the two or more documents may include two or more of a patent document, a specification of a patent document, a claim of a patent document, a description of an invention, or a title of an invention.

In some implementations of the method, the patent document may include one or more of an unpublished patent application, a published patent application, or a published patent.

In some implementations of the method, determining a topical distance between the two or more documents may include determining vector representations of the two or more documents, a first vector representing the first document and a second vector representing the second document, a first topical distance being the topical distance between the first document and the second document. In some implementations of the method, the first topical distance may be determined based on a distance between the first vector and the second vector.

In some implementations of the method, determining the first vector may include vectorizing terms and/or phrases in the first document.

In some implementations of the method, determining the first vector may include summing vectorized terms and/or phrases from the first document.

In some implementations of the method, determining the second vector may include vectorizing terms and/or phrases in the second document.

In some implementations of the method, determining the second vector may include summing vectorized terms and/or phrases from the second document.

In some implementations of the method, determining a topical distance between the two or more document may include predicting classifications of the two or more document, a first classification being predicted for the first document and a second classification being predicted for the second document, a first topical distance being the topical distance between the first document and the second document. In some implementations of the method, the first topical distance may be determined based on a distance between the first classification and the second classification.

In some implementations of the method, the classifications may be expressed by a hierarchical scheme.

In some implementations of the method, the distance between the first classification and the second classification may be determined based on a number of nodes crossed in the hierarchical scheme when traversing from the first classification and the second classification.

In some implementations of the method, the classifications may be in accord with a patent classification system used by a patent office.

In some implementations of the method, predicting the first classification may include applying a classification model to terms and/or phrases from the first document.

In some implementations of the method, predicting the second classification may include applying a classification model to terms and/or phrases from the second document.

In some implementations of the method, the classification model may include a machine-learning model trained on classification data.

In some implementations of the method, the classification data may include information from one or more of patent documents. In some implementations of the method, the one or more patent documents may include one or more of unpublished patent applications, published patent applications, or published patents.

In some implementations of the method, the information from the one or more patent documents may include one or both of text and/or classifications assigned by a patent office.

In some implementations of the method, the information from a given patent document may be included in the contents of the given patent document.

In some implementations of the method, determining whether the topical distance may breach the threshold includes determining a distance between the vector representations of the two or more document.

In some implementations of the method, determining whether the first topical distance may breach the first threshold includes calculating a distance in Euclidean n-space between the first vector and the second vector.

In some implementations of the method, determining whether the topical distance may breach the threshold includes determining a distance between the predicted classifications of the two or more document.

In some implementations of the method, determining whether the first topical distance breaches the first threshold may include counting a number of nodes crossed when traversing from the first classification to the second classification.

In some implementations of the method, the first document and the second document may be considered as being associated with independent and distinct inventions responsive to the first threshold is breached.

In some implementations of the method, the first document and the second document may be not considered to be associated with independent and distinct inventions responsive to the first threshold not being breached.

In some implementations of the method, the indication may convey that independent and distinct inventions are described in the two or more documents.

In some implementations of the method, the indication may convey that independent and distinct inventions are likely described in the two or more documents.

In some implementations of the method, the indication may convey that the two or more documents describe similar inventions.

In some implementations of the method, the indication may convey that the two or more documents describe potentially similar inventions.

In some implementations of the method, the indication may convey that further analysis is appropriate.

In some implementations of the method, the indication may convey that further analysis is likely appropriate.

In some implementations of the method, the indication may convey that further analysis is not likely appropriate.

In some implementations of the method, the further analysis may include human analysis.

In some implementations of the method, the further analysis may be to be performed by a patent practitioner.

In some implementations of the method, the patent practitioner may be preparing a patent application based on the first document.

Another aspect of the present disclosure relates to a system configured for determining potential subject matter conflicts among patent matters. The system may include one or more hardware processors configured by machine-readable instructions. The processor(s) may be configured to obtain two or more documents associated with patent documents. The two or more documents may include a first document and a second document. The processor(s) may be configured to determine a topical distance between the two or more documents, a first topical distance being the topical distance between the first document and the second document. The processor(s) may be configured to determine whether the topical distance between the two or more document breaches a threshold, a first threshold being associated with the first topical distance between the first document and the second document. The processor(s) may be configured to, responsive to a determination that the topical distance breaches the threshold, provide an indication that the threshold was breached.

Yet another aspect of the present disclosure relates to a non-transient computer-readable storage medium having instructions embodied thereon, the instructions being executable by one or more processors to perform a method for determining potential subject matter conflicts among patent matters. The method may include obtaining two or more documents associated with patent documents. The two or more documents may include a first document and a second document. The method may include determining a topical distance between the two or more documents, a first topical distance being the topical distance between the first document and the second document. The method may include determining whether the topical distance between the two or more document breaches a threshold, a first threshold being associated with the first topical distance between the first document and the second document. The method may include, responsive to a determination that the topical distance breaches the threshold, providing an indication that the threshold was breached.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured for determining potential subject matter conflicts among patent matters, in accordance with one or more implementations.

FIG. 2 illustrates a method for determining potential subject matter conflicts among patent matters, in accordance with one or more implementations.

FIG. 3 illustrates exemplary vector representations of two claim sets and a topical distance therebetween in a vector space, in accordance with one or more implementations.

FIG. 4 illustrates exemplary classifications of two claim sets and a topical distance therebetween in a hierarchical classification scheme, in accordance with one or more implementations.

### DETAILED DESCRIPTION

Methods, systems, and storage media for determining potential subject matter conflicts among patent matters are disclosed. Exemplary implementations may: obtain two or more documents associated with patent documents; determine a topical distance between the two or more documents, a first topical distance being the topical distance between the first document and the second document; determine whether the topical distance between the two or more document breaches a threshold, a first threshold being associated with the first topical distance between the first document and the second document; and responsive to a determination that the topical distance breaches the threshold, provide an indication that the threshold was breached.

A patent application has three main parts: claims, specification, and figures. The claims are a numbered list of sentences that precisely define what is being asserted as the invention. In other words, the claims attempt to define the boundary between what is regarded as prior art and what is considered as inventive (i.e., useful, new, and non-obvious). The specification is the longest section. It explains how to make and use the claimed invention. Finally, the figures complement the specification and depict the claimed features.

A claim set may be prepared by a human, a machine, or a human and machine working in concert. The claim set may include a numbered list of sentences that precisely define an invention. The claim set may include an independent claim and one or more dependent claims. Each dependent claim in the claim set may depend on the independent claim by referring to the independent claim or an intervening dependent claim.

A claim line may be a unit of text having an end indicated by a presence of one or more end-of-claim line characters. By way of non-limiting example, the one or more end-of-claim line characters may include one or more of a colon, a semi-colon, or a carriage return.

One or more claims and/or parts of a claim may be represented by a data structure. A given data structure may include a specialized format for organizing and storing data. In some implementations, by way of non-limiting example, the data structure may include one or more of an array, a list, two or more linked lists, a stack, a queue, a graph, a table, or a tree.

A claim may include one or more language elements. By way of non-limiting example, a language element may include one or more of a word, a phrase, a clause, or a sentence. A claim may be a single sentence. By way of non-limiting example, a sentence may include a set of words that is complete and contains a subject and predicate, a sentence including a main clause and optionally one or more subordinate clauses. By way of non-limiting example, a clause may include a unit of grammatical organization next below a sentence, a clause including a subject and predicate. A phrase may include a small group of words standing together as a conceptual unit, a phrase forming a component of a clause. By way of non-limiting example, a word may include a single distinct meaningful element of language used with others to form a sentence, a word being shown with a space on either side when written or printed.

A claim may include one or more language units. The one or more language units may be in patentese. The patentese may include text structure and legal jargon commonly used in patent claims.

The language units may be organized in a data structure according to one or more classifications of individual language elements. By way of non-limiting example, the one or more classifications may include one or more of independent claim, dependent claim, preamble, main feature, sub feature, claim line, clause, phrase, or word. A preamble of an independent claim preamble may convey a general description of the invention as a whole. A preamble of a dependent claim may include a reference to a preceding claim. In some implementations, a given main feature may include a step of a claimed process or a structural element of a non-method claim. In some implementations, a given sub feature may correspond to a given main feature. In some implementations, a given sub feature may describe or expands on an aspect of a corresponding main feature.

The specification of a patent application may include language units. One or more language units in the specification may be in prose rather than patentese. In some implementations, prose may include an ordinary form of written language, without structure of claim language, as distinguished from patentese. The prose may include permissive prose. In some implementations, the permissive prose conveying allowed but not obligatory concepts.

Some implementations may be configured to perform a natural language processing operation and/or natural language generation operation on data structures and/or contents of data structures. The natural language processing operation and/or natural language generation operation may be based on a machine learning model. By way of non-limiting example, the machine learning model may be based on one or more of a supervised learning algorithm, an unsupervised learning algorithm, a semi-supervised learning algorithm, a regression algorithm, an instance-based algorithm, a regularized algorithm, a decision tree algorithm, a Bayesian algorithm, a clustering algorithm, an association rule learning algorithm, an artificial neural network algorithm, a deep learning algorithm, a dimensionality reduction algorithm, or an ensemble algorithm. In some implementations, by way of non-limiting example, the machine learning system may include one or more of a sequence-to-sequence transformation, a recurrent neural network, a convolutional neural network, a finite-state transducers, or hidden Markov models.

By way of non-limiting example, the natural language generation operation may include one or more of paraphrase induction, simplification, compression, clause fusion, or expansion. Paraphrase induction may include preserving original meaning. By way of non-limiting example, paraphrase induction may include rewording and/or rearranging one or more of phrases, clauses, claim lines, or entire claims. Simplification may include preserving original meaning. Simplification may include splitting up a claim line for readability. Compression may include preserving important aspects. Compression may include deleting content for summarization. Fusion may include preserving important aspects. Fusion combining language elements for summarization. Expansion may include preserving original meaning and embellishing on the original content. Expansion may include introducing new content that supports or broadens the original meaning. Sentence semantics may be lossless with paraphrasing and simplification. Sentence semantics may be lossy with compression and fusion.

A one-to-one language element transformation may occur with paraphrasing and compression. A one-to-many language element transformation may occur with simplification. A many-to-one language element transformation may occur with fusion. The natural language generation operation may be performed according to a set of rules.

Some implementations determine a “topical distance” between different claim sets in a single patent application. A topical distance may be determined by determining a vector representation of different claim sets. A vector representation of a given claim set may be determined by vectorizing claim terms and/or phrases and summing the vectors. A topical distance may be determined by predicting a classification for different claim sets. In a hierarchical classification scheme, topical distance may be estimated by the relationship between two different classifications. For example, in the Cooperative Patent Classification (CPC) system (hierarchy: section (one letter A to H and also Y), class (two digits), subclass (one letter), group (one to three digits), main group and subgroups (at least two digits)), two classifications in the same subgroup have a closer topical distance compared to two classifications in the same section but different classes. According to some implementations, where a topical distance between two claim sets breaches a threshold, a restriction requirement may be appropriate.

Patent classification is a system for organizing all U.S. patent documents and other technical documents into specific technology groupings based on common subject matter. On Jan. 1, 2013, the USPTO moved from using the United States Patent Classification (USPC) system to the Cooperative Patent Classification (CPC) system, a jointly developed system with the European Patent Office (EPO). CPC has now been adopted by many countries throughout the world.

Patent publications are each assigned at least one classification term indicating the subject to which the invention relates and may also be assigned further classification and indexing terms to give further details of the contents. The CPC system has over 250,000 categories. Each classification term consists of a symbol such as “A01B33/00” (which represents “tilling implements with rotary driven tools”). The first letter is the “section symbol” consisting of a letter from “A” (“Human Necessities”) to “H” (“Electricity”) or “Y” for emerging cross-sectional technologies. This is followed by a two-digit number to give a “class symbol” (“A01” represents “Agriculture; forestry; animal husbandry; trapping; fishing”). The final letter makes up the “subclass” (A01B represents “Soil working in agriculture or forestry, parts, details, or accessories of agricultural machines or implements, in general”). The subclass is then followed by a 1- to 3-digit “group” number, an oblique stroke and a number of at least two digits representing a “main group” (“00”) or “subgroup”. Conventionally, a patent examiner assigns a classification to the patent application or other document at the most detailed level which is applicable to its contents.

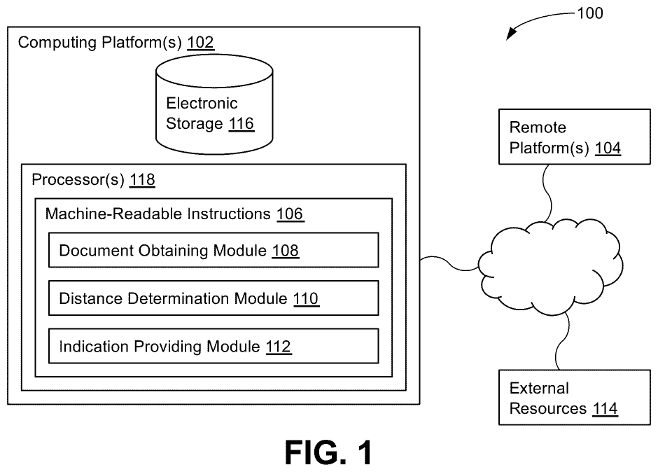

FIG. 1 illustrates a system 100 configured for determining potential subject matter conflicts among patent matters, in accordance with one or more implementations. In some implementations, system 100 may include one or more computing platforms 102. Computing platform(s) 102 may be configured to communicate with one or more remote platforms 104 according to a client/server architecture, a peer-to-peer architecture, and/or other architectures. Remote platform(s) 104 may be configured to communicate with other remote platforms via computing platform(s) 102 and/or according to a client/server architecture, a peer-to-peer architecture, and/or other architectures. Users may access system 100 via remote platform(s) 104.

Computing platform(s) 102 may be configured by machine-readable instructions 106. Machine-readable instructions 106 may include one or more instruction modules. The instruction modules may include computer program modules. The instruction modules may include one or more of document obtaining module 108, distance determination module 110, indication providing module 112, and/or other instruction modules.

Document obtaining module 108 may be configured to obtain two or more documents associated with patent documents. By way of non-limiting example, the two or more documents may include two or more of a patent document, a specification of a patent document, a claim of a patent document, a description of an invention, or a title of an invention. By way of non-limiting example, the patent document may include one or more of an unpublished patent application, a published patent application, or a published patent. The two or more documents may include a first document and a second document. By way of non-limiting example, determining a topical distance between the two or more documents may include determining vector representations of the two or more documents, a first vector representing the first document and a second vector representing the second document, a first topical distance being the topical distance between the first document and the second document.

Determining the first vector may include vectorizing terms and/or phrases in the first document. Determining the first vector may include summing vectorized terms and/or phrases from the first document. Determining the second vector may include vectorizing terms and/or phrases in the second document. Determining the second vector may include summing vectorized terms and/or phrases from the second document. By way of non-limiting example, determining a topical distance between the two or more document may include predicting classifications of the two or more document, a first classification being predicted for the first document and a second classification being predicted for the second document, a first topical distance being the topical distance between the first document and the second document. The classifications may be expressed by a hierarchical scheme.

The distance between the first classification and the second classification may be determined based on a number of nodes crossed in the hierarchical scheme when traversing from the first classification and the second classification. The classifications may be in accord with a patent classification system used by a patent office. Predicting the first classification may include applying a classification model to terms and/or phrases from the first document. Predicting the second classification may include applying a classification model to terms and/or phrases from the second document. The classification model may include a machine-learning model trained on classification data. The classification data may include information from one or more of patent documents.

By way of non-limiting example, the one or more patent documents may include one or more of unpublished patent applications, published patent applications, or published patents. The information from the one or more patent documents may include one or both of text and/or classifications assigned by a patent office. The information from a given patent document may be included in the contents of the given patent document. The first document and the second document may be considered as being associated with independent and distinct inventions responsive to the first threshold is breached. The first document and the second document may be not considered to be associated with independent and distinct inventions responsive to the first threshold not being breached.

Distance determination module 110 may be configured to determine a topical distance between the two or more documents, a first topical distance being the topical distance between the first document and the second document. The first topical distance may be determined based on a distance between the first vector and the second vector. The first topical distance may be determined based on a distance between the first classification and the second classification.

Distance determination module 110 may be configured to determine whether the topical distance between the two or more document breaches a threshold, a first threshold being associated with the first topical distance between the first document and the second document. Determining whether the topical distance may breach the threshold includes determining a distance between the vector representations of the two or more document. Determining whether the first topical distance may breach the first threshold includes calculating a distance in Euclidean n-space between the first vector and the second vector. Determining whether the topical distance may breach the threshold includes determining a distance between the predicted classifications of the two or more document. Determining whether the first topical distance breaches the first threshold may include counting a number of nodes crossed when traversing from the first classification to the second classification.

Indication providing module 112 may be configured to, responsive to a determination that the topical distance breaches the threshold, provide an indication that the threshold was breached. The indication may convey that independent and distinct inventions are described in the two or more documents. The indication may convey that independent and distinct inventions are likely described in the two or more documents. The indication may convey that the two or more documents describe similar inventions. The indication may convey that the two or more documents describe potentially similar inventions.

The indication may convey that further analysis is appropriate. The indication may convey that further analysis is likely appropriate. The indication may convey that further analysis is not likely appropriate. The further analysis may include human analysis. The further analysis may be to be performed by a patent practitioner. The patent practitioner may be preparing a patent application based on the first document.

In some implementations, computing platform(s) 102, remote platform(s) 104, and/or external resources 114 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 102, remote platform(s) 104, and/or external resources 114 may be operatively linked via some other communication media.

A given remote platform 104 may include one or more processors configured to execute computer program modules. The computer program modules may be configured to enable an expert or user associated with the given remote platform 104 to interface with system 100 and/or external resources 114, and/or provide other functionality attributed herein to remote platform(s) 104. By way of non-limiting example, a given remote platform 104 and/or a given computing platform 102 may include one or more of a server, a desktop computer, a laptop computer, a handheld computer, a tablet computing platform, a NetBook, a Smartphone, a gaming console, and/or other computing platforms.

External resources 114 may include sources of information outside of system 100, external entities participating with system 100, and/or other resources. In some implementations, some or all of the functionality attributed herein to external resources 114 may be provided by resources included in system 100.

Computing platform(s) 102 may include electronic storage 116, one or more processors 118, and/or other components. Computing platform(s) 102 may include communication lines, or ports to enable the exchange of information with a network and/or other computing platforms. Illustration of computing platform(s) 102 in FIG. 1 is not intended to be limiting. Computing platform(s) 102 may include a plurality of hardware, software, and/or firmware components operating together to provide the functionality attributed herein to computing platform(s) 102. For example, computing platform(s) 102 may be implemented by a cloud of computing platforms operating together as computing platform(s) 102.

Electronic storage 116 may comprise non-transitory storage media that electronically stores information. The electronic storage media of electronic storage 116 may include one or both of system storage that is provided integrally (i.e., substantially non-removable) with computing platform(s) 102 and/or removable storage that is removably connectable to computing platform(s) 102 via, for example, a port (e.g., a USB port, a firewire port, etc.) or a drive (e.g., a disk drive, etc.). Electronic storage 116 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 116 may include one or more virtual storage resources (e.g., cloud storage, a virtual private network, and/or other virtual storage resources). Electronic storage 116 may store software algorithms, information determined by processor(s) 118, information received from computing platform(s) 102, information received from remote platform(s) 104, and/or other information that enables computing platform(s) 102 to function as described herein.

Processor(s) 118 may be configured to provide information processing capabilities in computing platform(s) 102. As such, processor(s) 118 may include one or more of a digital processor, an analog processor, a digital circuit designed to process information, an analog circuit designed to process information, a state machine, and/or other mechanisms for electronically processing information. Although processor(s) 118 is shown in FIG. 1 as a single entity, this is for illustrative purposes only. In some implementations, processor(s) 118 may include a plurality of processing units. These processing units may be physically located within the same device, or processor(s) 118 may represent processing functionality of a plurality of devices operating in coordination. Processor(s) 118 may be configured to execute modules 108, 110, and/or 112, and/or other modules. Processor(s) 118 may be configured to execute modules 108, 110, and/or 112, and/or other modules by software; hardware; firmware; some combination of software, hardware, and/or firmware; and/or other mechanisms for configuring processing capabilities on processor(s) 118. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 108, 110, and/or 112 are illustrated in FIG. 1 as being implemented within a single processing unit, in implementations in which processor(s) 118 includes multiple processing units, one or more of modules 108, 110, and/or 112 may be implemented remotely from the other modules. The description of the functionality provided by the different modules 108, 110, and/or 112 described below is for illustrative purposes, and is not intended to be limiting, as any of modules 108, 110, and/or 112 may provide more or less functionality than is described. For example, one or more of modules 108, 110, and/or 112 may be eliminated, and some or all of its functionality may be provided by other ones of modules 108, 110, and/or 112. As another example, processor(s) 118 may be configured to execute one or more additional modules that may perform some or all of the functionality attributed below to one of modules 108, 110, and/or 112.

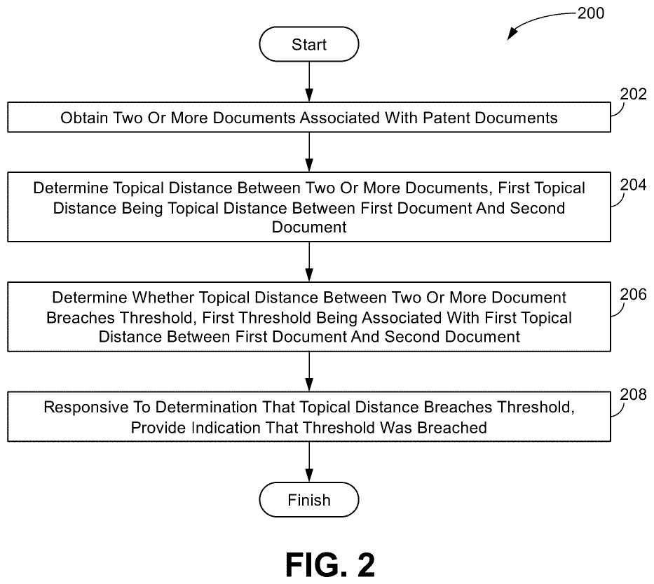

FIG. 2 illustrates a method 200 for determining potential subject matter conflicts among patent matters, in accordance with one or more implementations. The operations of method 200 presented below are intended to be illustrative. In some implementations, method 200 may be accomplished with one or more additional operations not described, and/or without one or more of the operations discussed.

Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include obtaining two or more documents associated with patent documents. The two or more documents may include a first document and a second document. Operation 202 may be performed by one or more hardware processors configured by machine-readable instructions including a module that is the same as or similar to document obtaining module 108, in accordance with one or more implementations.

An operation 204 may include determining a topical distance between the two or more documents, a first topical distance being the topical distance between the first document and the second document. Operation 204 may be performed by one or more hardware processors configured by machine-readable instructions including a module that is the same as or similar to distance determination module 110, in accordance with one or more implementations.

An operation 206 may include determining whether the topical distance between the two or more document breaches a threshold, a first threshold being associated with the first topical distance between the first document and the second document. Operation 206 may be performed by one or more hardware processors configured by machine-readable instructions including a module that is the same as or similar to distance determination module 110, in accordance with one or more implementations.

An operation 208 may include responsive to a determination that the topical distance breaches the threshold, providing an indication that the threshold was breached. Operation 208 may be performed by one or more hardware processors configured by machine-readable instructions including a module that is the same as or similar to indication providing module 112, in accordance with one or more implementations.

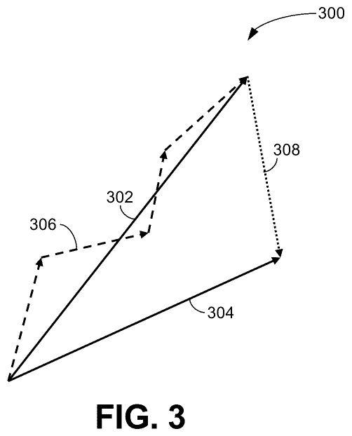

FIG. 3 illustrates exemplary vector representations 300 of two claim sets and a topical distance therebetween in a vector space, in accordance with one or more implementations. Vector representations 300 include a first vector 302 and a second vector 304. The first vector 302 may represent a first claim set. The first vector 302 may be determined based on a sum of vectors 306 representing individual terms and/or phrases in the first claim set. The second vector 304 may represent a second claim set. The second vector 304 may be determined based on a sum of vectors (not shown) representing individual terms and/or phrases in second first claim set. A topical distance between the first claim set and the second claim set may be determined based on a vector 308 between the first vector 302 and the second vector 304.

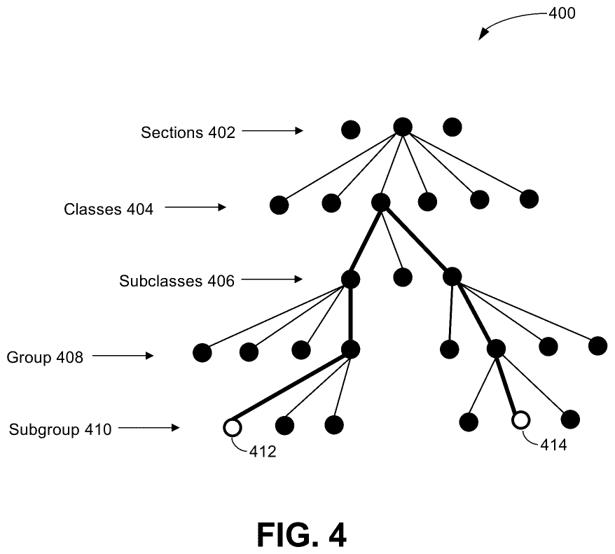

FIG. 4 illustrates exemplary classifications of two claim sets and a topical distance therebetween in a hierarchical classification scheme 400, in accordance with one or more implementations. The hierarchical classification scheme 400 may include sections 402, classes 404, subclasses 406, groups 408, subgroups 410, and/or other classifications. A classification 412 may be identified based on the specific section 402, class 404, subclass 406, group 408, subgroup 410, and/or other classifications to which classification 412 belongs. A topical distance may be determined between classification 412 and a different classification 414. The topical distance may be determined based on a number of nodes crossed when traversing from classification 412 to classification via the hierarchical classification scheme 400. The number of nodes crossed when traversing from classification 412 to classification 414, as illustrated in FIG. 4, is five nodes. The fewer the number of nodes separating two classifications, the more closely they are related. The greater the number of nodes separating two classifications, the less closely they are related.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A method for determining potential subject matter conflicts among patent matters, the method comprising:
obtaining two or more documents associated with patent documents, the two or more documents including a first document and a second document;
determining a topical distance between the two or more documents, a first topical distance being the topical distance between the first document and the second document;
determining whether the topical distance between the two or more document breaches a threshold, a first threshold being associated with the first topical distance between the first document and the second document; and
responsive to a determination that the topical distance breaches the threshold, providing an indication that the threshold was breached.

2. The method of claim 1, wherein the two or more documents include two or more of a patent document, a specification of a patent document, a claim of a patent document, a description of an invention, or a title of an invention.

3. The method of claim 2, wherein the patent document includes one or more of an unpublished patent application, a published patent application, or a published patent.

4. The method of claim 1, wherein determining a topical distance between the two or more documents includes determining vector representations of the two or more documents, a first vector representing the first document and a second vector representing the second document, a first topical distance being the topical distance between the first document and the second document, the first topical distance being determined based on a distance between the first vector and the second vector.

5. The method of claim 4, wherein determining whether the topical distance breaches the threshold includes determining a distance between the vector representations of the two or more document.

6. The method of claim 1, wherein determining a topical distance between the two or more document includes predicting classifications of the two or more document, a first classification being predicted for the first document and a second classification being predicted for the second document, a first topical distance being the topical distance between the first document and the second document, the first topical distance being determined based on a distance between the first classification and the second classification.

7. The method of claim 6, wherein the classifications are expressed by a hierarchical scheme.

8. The method of claim 6, wherein the distance between the first classification and the second classification is determined based on a number of nodes crossed in the hierarchical scheme when traversing from the first classification and the second classification.

9. The method of claim 6, wherein predicting the first classification includes applying a classification model to terms and/or phrases from the first document, wherein the classification model includes a machine-learning model trained on classification data.

10. The method of claim 6, wherein determining whether the topical distance breaches the threshold includes determining a distance between the predicted classifications of the two or more document.

11. The method of claim 10, wherein determining whether the first topical distance breaches the first threshold includes counting a number of nodes crossed when traversing from the first classification to the second classification.

12. The method of claim 1, wherein the first document and the second document are considered as being associated with independent and distinct inventions responsive to the first threshold is breached.

13. The method of claim 1, wherein the first document and the second document are not considered to be associated with independent and distinct inventions responsive to the first threshold not being breached.

14. The method of claim 1, wherein the indication conveys that independent and distinct inventions are described in the two or more documents.

15. The method of claim 1, wherein the indication conveys that independent and distinct inventions are likely described in the two or more documents.

16. The method of claim 1, wherein the indication conveys that the two or more documents describe similar inventions.

17. The method of claim 1, wherein the indication conveys that the two or more documents describe potentially similar inventions.

18. The method of claim 1, wherein the indication conveys that further analysis is appropriate, wherein the indication conveys that further analysis is likely appropriate, or wherein the indication conveys that further analysis is not likely appropriate.

19. A system configured for determining potential subject matter conflicts among patent matters, the system comprising:
one or more hardware processors configured by machine-readable instructions to:
obtain two or more documents associated with patent documents, the two or more documents including a first document and a second document;
determine a topical distance between the two or more documents, a first topical distance being the topical distance between the first document and the second document;
determine whether the topical distance between the two or more document breaches a threshold, a first threshold being associated with the first topical distance between the first document and the second document; and
responsive to a determination that the topical distance breaches the threshold, provide an indication that the threshold was breached.

20. A non-transient computer-readable storage medium having instructions embodied thereon, the instructions being executable by one or more processors to perform a method for determining potential subject matter conflicts among patent matters, the method comprising:
obtaining two or more documents associated with patent documents, the two or more documents including a first document and a second document;
determining a topical distance between the two or more documents, a first topical distance being the topical distance between the first document and the second document;
determining whether the topical distance between the two or more document breaches a threshold, a first threshold being associated with the first topical distance between the first document and the second document; and
responsive to a determination that the topical distance breaches the threshold, providing an indication that the threshold was breached.
